(19) United States
(12) Patent Application Publication
(10) Pub. No.: US 2016/0231825 A1
(43) Pub. Date: Aug. 11, 2016

(54) GESTURE CONTROL DEVICE, METHOD, SYSTEM AND STORAGE MEDIUM

(71) Applicant: KONINKLIJKE PHILIPS N.V., Eindhoven (NL)

(72) Inventor: Paulus Thomas Arnoldus THIJSSEN, Goirle (NL)

(21) Appl. No.: 15/022,947

(22) PCT Filed: Oct. 3, 2014
(86) PCT No.: PCT/EP2014/071229

§ 371 Date: Mar. 18, 2016

(30) Foreign Application Priority Data
Oct. 14, 2013 (EP) 13188476.9

(51) Int. Cl. G06F 3/01

(52) U.S. Cl. CPC G06F 3/017

(57) ABSTRACT

A gesture control device (10) for use with a controllable device (20) is provided, wherein said gesture control device enables controlling a magnitude (M) of a perceivable output (O) of the controllable device within a predetermined magnitude range according to a magnitude control gesture. The gesture control device includes a gesture control interface (12) to recognize gestures and to provide an detection signal (D) indicative of recognized gestures. The gesture control device further includes a magnitude control unit (14) for in response to said detection signal (D) generating a device control signal indicative for the magnitude (I) of the perceivable output (O). The gesture control interface (12) is capable of recognizing at least one sub-range select gesture that corresponds to a selection by said magnitude control unit (14) of a magnitude sub-range of said predetermined magnitude range and the magnitude control unit (14) limits the controlled magnitude to within said magnitude sub-range.

### BACKGROUND OF THE INVENTION

1. Field of the Invention

The present invention relates to a gesture control device for use with a controllable device.

The present invention also relates to a gesture control method for use with a controllable device.

The present invention also relates to a storage medium comprising a program that when executed performs all steps of said method.

The present invention also relates to a system comprising a gesture control device and a controllable device.

2. Related Art

Gesture control is more and more getting adopted by the market. Different technologies are being applied, such as:

Optical sensors

Capacitive sensors

Ultrasound sensors

2D camera technology

3D camera technology (e.g. time of flight)

From a cost perspective, the first three technologies are particularly attractive for use in high volume applications. One example is the Philips Shoqbox product. This product features gesture control via an optical sensor. So far, only discrete gestures are supported to jump to the next/previous song, or to mute/unmute audio. Light-dimming is another possible application for gesture control, wherein a movement of a hand within a certain spatial range has the effect of light intensity within an intensity range.

Controlling a magnitude of a perceivable output of a controllable device, such as an audio volume or a light intensity, is relatively intuitive in systems having a physical user control facility, such as a rotatable or slidable knob or virtual user control facility, such as a simulation of such a knob on a touch-screen.

It is noted that US2007/126696 discloses a system and method for mapping a virtual user interface to a graphical user interface. The method can include identifying a range of object movement in a first coordinate system of the Virtual User Interface, identifying a display range in a second coordinate system of the graphical user interface (GUI), and mapping the range of object motion to the display range to produce a virtual mapping. The GUI can be on a display such as a computer monitor, a laptop display, or a mobile communication device such as cell phone, a portable music player, a personal digital assistant, or any other suitable communication device. The GUI can include components, such as a media control 104 which can be controlled via touchless sensing in the VUI.

Contrary to physically controlled devices, in gesture controlled systems it may be more difficult for a user to estimate the effect of a gesture on the controlled device and unintended movements may result in discomforting or disastrous effects on the controlled device. For example, in a light-dimming application a movement of the users hand may cause the light unexpectedly to overshoot to maximum intensity, which may be discomforting. In a sound-control application an unintended overshoot to maximum volume may result in a damage of the speakers.

### SUMMARY OF THE INVENTION

It is an object of the present invention to provide a gesture control device that provides for an improved control of the controlled device.

It is a further object of the present invention to provide a gesture control method that provides for an improved control of the controlled device.

It is a still further object of the present invention to provide a storage medium comprising a program that when executed performs all steps of said improved method.

It is a still further object of the present invention to provide a system comprising an improved gesture control device and a controllable device.

According to a first aspect of the invention a gesture control device for use with a controllable device is provided, wherein said gesture control device enables controlling a magnitude of a perceivable output of the controllable device within a predetermined magnitude range according to a magnitude control gesture, the gesture control device including

a gesture control interface for providing an detection signal indicative of detected gestures,

a magnitude control unit for in response to said detection signal generating a device control signal indicative for the magnitude of the perceivable output, wherein the gesture control interface is further capable of recognizing at least one sub-range select gesture that corresponds to a selection by said magnitude control unit of a sub-range of said predetermined magnitude range and wherein said gesture control device limits the controlled magnitude to within said sub-range. In the gesture control device according to the present invention, the instantaneously available range of magnitudes is restricted to a sub-range of the range of magnitudes that is made potentially available by the controlled device. Therewith the improved gesture control device prevents that the user can inadvertently change the controllable magnitude to an unintended high (or low) level. Nevertheless, the user still can control the magnitude within the potentially available range by indicating the proper magnitude sub-range with the at least one sub-range select gesture.

Typical applications of the present invention include light intensity control, audio volume control and temperature control. Also other applications are possible wherein an improved control by gestures is desirable, such as light color control, scrolling through lists, image manipulation (scaling, rotating) etc.

Various options are possible to effect the selection of the magnitude sub-range. The magnitude sub-range may for example be effected in that the magnitude indicated by the detection signal is clipped between the boundaries of the sub-range. In an embodiment selection of the sub-range is effected by mapping an available range for said magnitude control gesture to said sub-range. The range for the magnitude control gesture is for example a position of the user's hand or other object between a first boundary and a second boundary, wherein the first boundary corresponds to the lowest magnitude of the sub-range and the second boundary corresponds to the highest magnitude of the sub-range. In this way it is not only achieved that the magnitude is limited to said sub-range, but also it is achieved that the user can more accurately control the magnitude than would be possible by merely clipping.

Various options are possible for the magnitude control gesture. The magnitude control gesture may for example indicate a desired value of a magnitude by a position or an angle, e.g. the position of a hand or an angle of a direction pointed at. Alternatively the magnitude control gesture may indicate a desired value of a magnitude by a velocity or a frequency, e.g. the velocity of a moving hand or the frequency of a waving hand. Throughout the wording position is used to indicate a point on a scale accessible for the magnitude control gesture. For simplicity it will be assumed that the position is normalized on a scale between 0 and 1. E.g. a frequency f of a waving hand in a range from 1 to 5 Hz may be normalized to a position on this scale so that P=⅕ f. Likewise an angle α indicated by an arm in a range from 0 to 360 degrees may be normalized to a position on this scale, so that P=α/360.

The gesture control interface 12 may use a contactless sensing mechanism. For example a sensor may be provided that uses visual radiation to sense the environment, e.g. visual radiation from a lighting installation arranged in the environment. However, this is not necessary. For example, the sensor may use infrared radiation irradiated by the person operating the gesture control device. In an embodiment the sensor is a time of flight (ToF) sensor. This type of sensor typically includes an infrared radiation source which irradiates infrared radiation and measures the time delay with which the light reflected by the object is received as a measure for the depth. Also various other ways are known to implement such a type of sensor. Also other gesture detection methods can be applied using ultrasound or WiFi. Alternatively, the gestures observed may be traces observed by a touch pad, e.g. swiping movements.

It is noted that the controlled magnitude does not necessarily relate in a linear manner to the position or other variable indicated by the gesture. In embodiments the magnitude may for example vary as a logarithmic function or other function of the position or other variable.

In an embodiment the at least one sub-range select gesture comprises a first and a second sub-range select gesture, wherein the first sub-range select gesture corresponds to a selection by said magnitude control unit of a sub-range of lower magnitudes than a currently selected sub-range and wherein the second sub-range select gesture corresponds to a selection by said magnitude control unit of a sub-range of higher magnitudes than the currently selected magnitude range. This provides a very practical way of controlling the magnitude.

In an embodiment the gesture control interface is capable of recognizing a position of an object within a first and a second spatial boundary, and wherein the first sub-range select gesture is a transition of the object through the first spatial boundary, in a direction from the second spatial boundary to the first spatial boundary, wherein the second sub-range select gesture is a transition of the object through the second spatial boundary, in a direction from the first spatial boundary to the second spatial boundary, and wherein the magnitude control gesture is one of position and a movement of the object between said first and said second spatial boundary. In this way a very intuitive way of control is provided. The user attempting to achieve a higher magnitude than is available with the currently selected magnitude sub-range can naturally indicate this by moving his/hers hand beyond the second spatial boundary and therewith select the higher ranked magnitude sub-range. Similarly, the user attempting to achieve a lower magnitude than is available with the currently selected magnitude sub-range can naturally indicate this by moving his/hers hand beyond the first spatial boundary and therewith select the lower ranked magnitude sub-range.

In an embodiment a reference position between the first and the second spatial boundary corresponds to a current setting of the magnitude, wherein the reference position is distanced from a central position between the first and the second boundary. This implies that the available part of the magnitude sub-range having a magnitude higher than the currently selected magnitude differs from the available part of the magnitude sub-range having a magnitude lower than the currently selected magnitude. For example the reference position may be arranged at a distance from the lower spatial boundary corresponding to twice the distance between the reference position and the higher boundary.

In another embodiment of the gesture control device according to the first aspect of the invention, said at least one sub-range select gesture is an absence of a magnitude control gesture for a predetermined minimum amount of time, wherein upon detection of said absence for the predetermined amount of time the current sub-range is set to a sub-range of magnitudes ranging from a lower magnitude being equal to the presently selected magnitude minus a first delta value to a higher magnitude being equal to the presently selected magnitude plus a second delta value. The user may for example indicate by raising a hand that the magnitude, such as a sounds volume should increase from a present level to a higher level within the currently available magnitude sub-range. Alternatively, the user may indicate that a lower volume is desired by lowering the hand. If it is detected that the user has not indicated a change in magnitude for the predetermined amount of time, the current magnitude sub-range is replaced by a new magnitude sub-range around the currently selected magnitude. The new magnitude sub-range may be symmetrically arranged around the currently selected magnitude. Alternatively the new magnitude sub-range may be asymmetrically arranged. For example in this way it may be achieved as a safety measure that the user can more easily decrease the magnitude than increase the magnitude. The choice of the delta values may depend on the currently selected magnitude. For example in case of a relatively low currently selected magnitude the first delta value may be smaller than the second delta value, whereas in case of a relatively high currently selected magnitude the first delta value may be larger than the second delta value.

According to a further aspect of the present invention a gesture control method is provided for use with a controllable device, wherein said gesture control device enables controlling a magnitude of a perceivable output of the controllable device within a predetermined magnitude range using a magnitude control gesture.

The gesture control method according to the first aspect includes

providing a detection signal indicative of detected gestures, where

in response to a sub-range select gesture said detection signal has the effect of selecting a sub-range of said predetermined magnitude range and

in response to a magnitude control gesture providing a control signal that is indicative for a magnitude limited to said sub-range and

controlling the controllable device with said control signal.

According to a further aspect of the present invention a storage medium is provided comprising a program that when executed by a programmable device performs the steps of this method.

According to a still further aspect a system is provided comprising a gesture control device according to the first aspect and a controllable device controlled by the gesture control device. The controllable device may for example be a lighting unit, an audio visual unit or a personal computer.

### BRIEF DESCRIPTION OF THE DRAWINGS

These and other aspects are described in more detail with reference to the drawing. Therein:

FIG. 1 schematically shows a gesture control device according to the present invention, as well as a controllable device, the gesture control device and the controllable device forming a system according to the present invention,

FIGS. 1A 1D shows various gestures that may be recognized by the gesture control device.

FIG. 2 schematically shows an embodiment of a gesture control device according to the first aspect of the invention,

FIG. 3 illustrates a response of the gesture control device of FIG. 2,

FIG. 3A illustrates a response of a variation of the gesture control device of FIG. 2,

FIG. 4 illustrates the response of the gesture control device of FIG. 2 in another way,

FIG. 5 illustrates a response of another variation of the gesture control device of FIG. 2,

FIG. 6 illustrates a response for another embodiment of a gesture control device according to the first aspect of the invention,

FIG. 7 illustrates a practical implementation of that embodiment,

FIG. 8 illustrates a response for again another embodiment of a gesture control device according to the first aspect of the invention,

FIG. 9 illustrates a practical implementation of that embodiment.

### DETAILED DESCRIPTION OF EMBODIMENTS

Like reference symbols in the various drawings indicate like elements unless otherwise indicated.

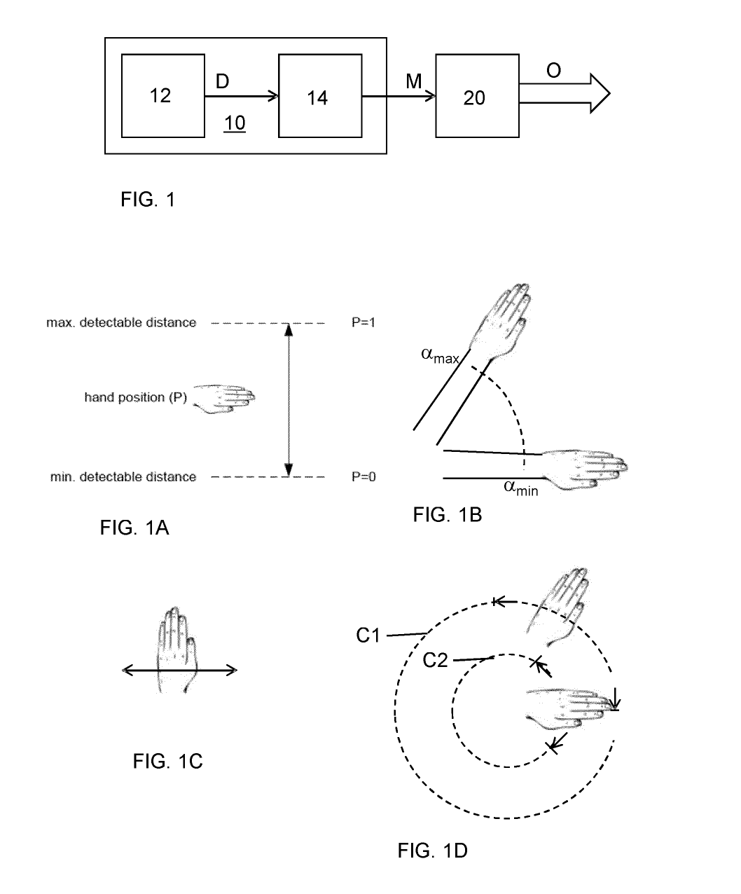

FIG. 1 shows a gesture control device 10 for use with a controllable device 20. The controllable device provides an output O having a perceivable magnitude I, also denoted as O(I). The gesture control device enables controlling the magnitude I of the perceivable output O of the controllable device within a predetermined magnitude range according to a magnitude control gesture. The controllable device 20 is for example a lighting unit having as the controllable magnitude a light intensity or an audio installation having a controllable audio volume. The gesture control device 10 and the controllable device 20 together form a (controllable) system.

The gesture control device 10 shown in FIG. 1 includes a gesture control interface 12 to provide a detection signal D indicative of detected gestures and a magnitude control unit 14 that in response to said detection signal D generates a device control signal M indicative for the magnitude I of the perceivable output O. The gesture control interface 12 is further capable of recognizing at least one sub-range select gesture that corresponds to a selection by said magnitude control unit 14 of a magnitude sub-range of said predetermined magnitude range and wherein said gesture control device limits the controlled magnitude to within said magnitude sub-range.

As indicated above, depending on the application various alternative gestures may be used. FIG. 1A shows a first example wherein the gesture for indicating a desired magnitude is the position P of a hand within a detection range from min. detectable distance to max. detectable distance. By way of example the detected position is indicated as a value in the range of 0 to 1 in this range. Alternatively, as shown in FIG. 1B, the gesture used may be an angle, e.g. an angle between a minimum value αₘᵢₙ and a maximum value αₘₐₓ, wherein the minimum value αₘₘ corresponds to P=0 and the maximum value αₘₐₓ corresponds to P=1. According to again another alternative as shown in FIG. 1C, the magnitude control gesture may be a velocity or a frequency, e.g. the velocity of a moving hand or the frequency of a waving hand. E.g. a frequency f of a waving hand in a range from 1 to 5 Hz may be normalized to a position on this scale so that P=⅕ f. Likewise an angle α indicated by an arm in a range from 0 to 360 degrees may be normalized to a position on this scale, so that P=α/360.

The gesture control interface 12 may in addition to the value P further provide signals UP/DOWN/HOLD to indicate whether the value P currently is increasing or decreasing or that no change is observed respectively. The gesture control interface 12 may further separately indicate (MAX/MIN) that an upper or lower boundary position is reached. Alternatively the magnitude control unit 14 may derive these signals from the value P indicated by the gesture control interface 12. The gesture control interface 12 may further indicate a state wherein no gesture is detected at all.

The gesture control device 10 may have provisions to take into account an accuracy with which the user can make the gesture. For example, as shown in FIG. 1D, the user may indicate a desired magnitude by waiving the hand along an angular part of a circle C1, C2. It may be taken into account that the user can more accurately specify a certain angle when moving along the wider circle C1 than when moving along the smaller circle C2.

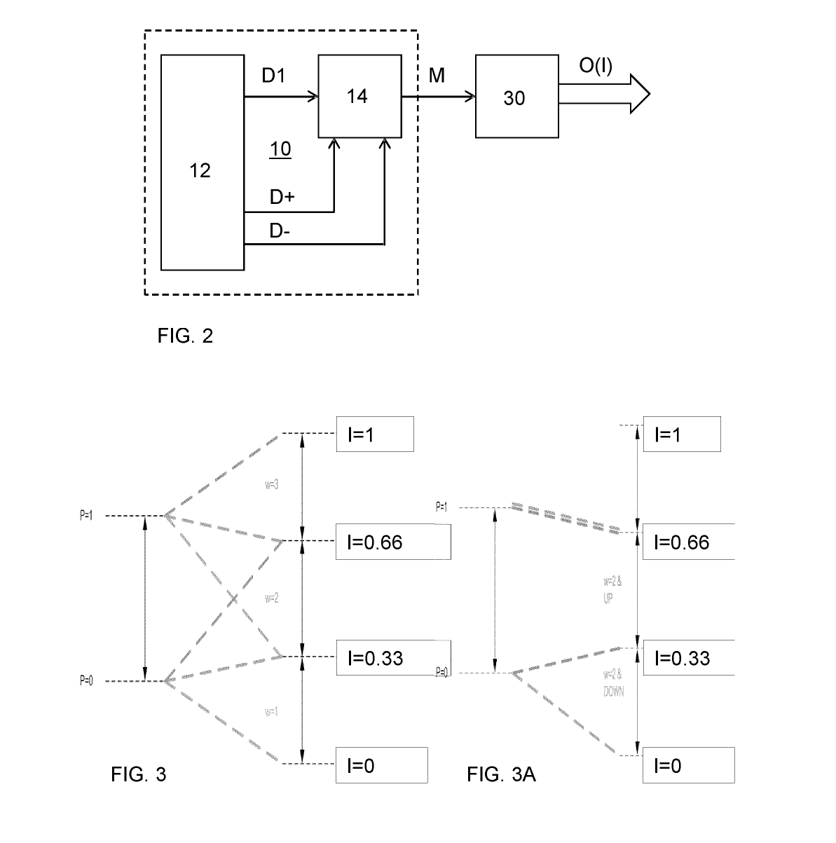

FIG. 2 shows an embodiment, wherein the at least one sub-range select gesture comprises a first and a second sub-range select gesture. The gesture control interface 12 is arranged to provide an detection signal D1 in response to a magnitude control gesture that is indicative for a desired value of the magnitude within the currently prevailing sub-range. In addition the gesture control interface 12 is arranged to provide an detection signal D− in response to a first sub-range select gesture suitable for a user to indicate that a magnitude sub-range of lower magnitudes is desired than the currently selected one. In response to this detection signal D− the magnitude control unit 14 selects the lower ranked magnitude sub-range. The gesture control interface 12 is further arranged to provide an detection signal D+ in response to a second sub-range select gesture suitable for a user to indicate that a magnitude sub-range of higher magnitudes is desired than the currently selected one. In response to this detection signal D+ the magnitude control unit 14 selects the higher ranked magnitude sub-range.

In a practical example, the magnitude I indicated by the device control signal M of control unit 14 of FIG. 2 is:

$$I = ( \frac{w - 1}{N} ) + ( \frac{1}{N} ) P$$

Therein I is a magnitude in a range from 0 corresponding to a lowest magnitude to 1, corresponding to a highest magnitude. P is a normalized position in a range from 0 to 1 as indicated by the signal D1 in response to the magnitude control gesture. Therein 0 indicates the position of the first boundary, 1 indicates the position of the second boundary and a value between 0 and 1 indicates a position between those boundaries.

Furthermore w indicates a currently selected window, wherein w is a natural number in the range of 1 to N.

FIG. 3 illustrates an example wherein the number N of windows of the magnitude control unit 14 is equal to 3. Operation of the gesture control device of FIG. 2 is now described with reference to FIG. 3. Suppose that w=2 is the currently selected window. In case the user can vary the magnitude I between 0.33 and 0.66 by varying the normalized position P as indicated with the magnitude control gesture over the entire available range from 0 to 1 of normalized positions. If the user indicates with the first sub-range select gesture that a lower ranked magnitude sub-range is desired, the corresponding detection signal D− of the gesture control interface 12 causes the magnitude control unit 14 to select the lower ranked magnitude sub-range (w=1). In that state of the magnitude control unit 14 the user can vary the magnitude I between 0 and 0.33 by varying the normalized position P as indicated with the magnitude control gesture over the entire available range from 0 to 1 of normalized positions.

Alternatively, if the user indicates with the second sub-range select gesture that a higher ranked magnitude sub-range is desired, the corresponding detection signal D+ of the gesture control interface 12 causes the magnitude control unit 14 to select the higher ranked magnitude sub-range (w=3). In that state of the magnitude control unit 14 the user can vary the magnitude I between 0.66 and 1 by varying the normalized position P as indicated with the magnitude control gesture over the entire available range from 0 to 1 of normalized positions.

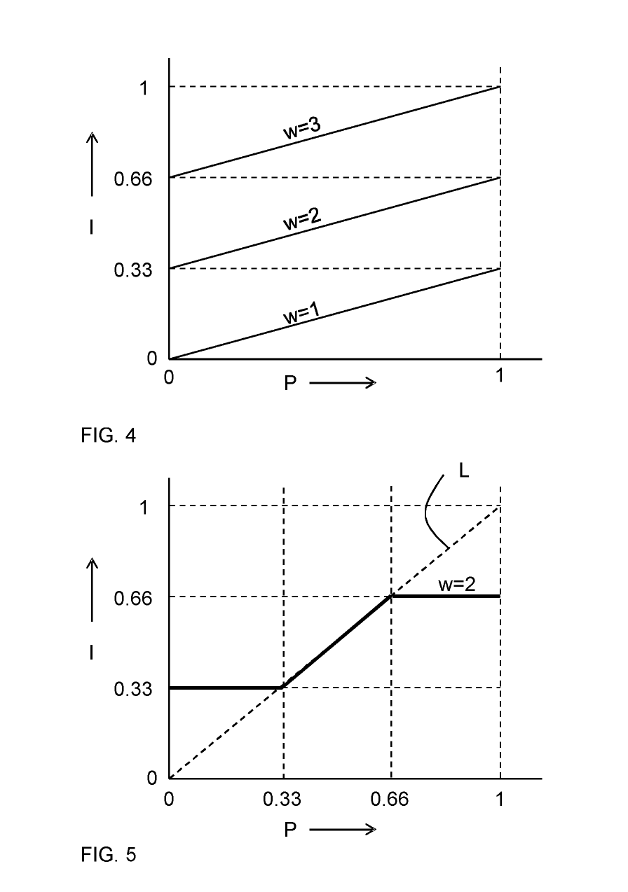

FIG. 4 provides for an additional illustration of the operation of the gesture control device 10. As can be clearly seen in FIG. 4, a selection of the magnitude sub-range is effected by mapping the available control range (P=0 to P=1) to a magnitude sub-range corresponding to the window w of the predetermined magnitude range (I=0 to I=1). For example, for the window w=2, the available control range (P=0 to P=1) is mapped to the magnitude sub-range from 0.33 to 0.66.

FIG. 5 shows an alternative way in which a selection of the magnitude sub-range may be effected. Herein the dashed slanted line L indicates the relation between the magnitude I and the normalized position P that would exist if the user could control the magnitude over the full the predetermined magnitude range (I=0 to I=1). The continuous line indicates the relation between the magnitude I and the normalized position P according to this alternative way in which a selection of the magnitude sub-range is effected. Therein the controlled magnitude I is clipped between the lower and higher boundary for the prevailing range (here 0.33 and 0.66 for the window w=2). Otherwise stated sub-range is selected of the position range wherein a change of position has effect. In this example increasing the position P to a value higher than 0.66 does not further increase the magnitude I and decreasing the position P to a value lower than 0.33 does not further decrease the magnitude I. However, within these boundaries the controlled magnitude corresponds to the magnitude that would be assigned if the user could control the magnitude over the full predetermined magnitude range (I=0 to I=1).

From a comparison it can be seen that on the one hand the method illustrated in FIG. 4 is advantageous in that the user can control the magnitude with a relatively high precision, as the slope of the controlled magnitude I as a function of the position P is relatively small. On the other hand the method illustrated in FIG. 5 is advantageous in that for the selected window of amplitudes, here w=2, the magnitude I assigned to a position P corresponds to the magnitude that would be assigned if the magnitude would be controllable over the entire range by indicating a position within the available range of positions. This may facilitate a user to correlate a certain position with a certain magnitude.

In the embodiments described with reference to FIG. 2-5, the gesture control device 10 responds in a symmetric way to a position indicated by the magnitude control gesture. I.e. the extent to which the controlled magnitude I increases when increasing the value for P with a certain amount corresponds to the extent to which the controlled magnitude I decreases when decreasing the indicated position with that amount.

In certain circumstances an asymmetric response may be desired. For example it may be desired that the user can rapidly control the volume of an audio device to 0, whereas it may be undesired that the user can easily control the volume to the maximum possible level. Accordingly, the following embodiment may be provided. Therein the response to an increasing gesture position P as illustrated in FIG. 3A corresponds to the response of the magnitude control unit described with reference to FIG. 2-5, i.e

$$I = ( \frac{w - 1}{N} ) + ( \frac{1}{N} ) P$$

However, moving downwards the response I is:

$$I = ( \frac{w}{N} ) P$$

Accordingly, for example in case the number of windows w=3 of which the window w=2 is currently selected, a user may control the magnitude I downwards from I=0.66 to I=0.

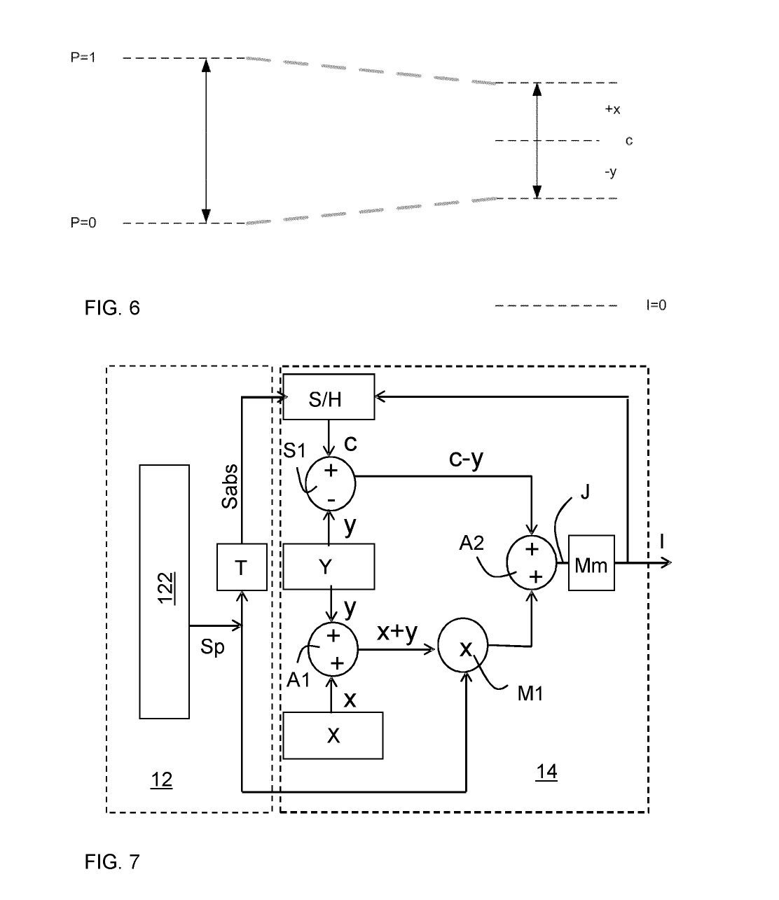

In an embodiment as illustrated in FIGS. 6 and 7, the at least one sub-range select gesture is an absence of a magnitude control gesture for a predetermined minimum amount of time. If an absence for the predetermined amount of time is detected, e.g. no magnitude control gesture has been recognized for said predetermined minimum amount of time, the current magnitude sub-range is set to a sub-range of magnitudes ranging from a lower magnitude being equal to a presently selected magnitude (c) minus a first delta value (y) to a higher magnitude being equal to the presently selected magnitude plus a second delta value (x), see FIG. 6. The values for x and y may be the same, at least substantially, e.g. differing at most 10%, in which case the magnitude sub-range is (approximately) symmetrically arranged around the presently selected magnitude. Alternatively, the values for x and y may be different, e.g. differing more than 10%, for example to achieve that the user can more easily attenuate the intensity than increase the intensity. The predetermined minimum amount of time may for example be selected in a range between 1 sec and 1 min, preferably between 2 sec and 20 sec, e.g. 5 sec.

FIG. 7 shows a practical implementation. In the embodiment shown therein the gesture control interface 12 comprises a gesture recognition module 122 that is capable of recognizing a magnitude control gesture. The gesture recognition module 122 issues a signal Sp indicating whether it has recognized a magnitude control gesture. The signal Sp further indicates the value p associated with the current magnitude control gesture or if no magnitude control gesture is currently recognized, the value p for the current magnitude control gesture last observed. The gesture control interface 12 further comprises a timer module T that issues a clock signal Sabs when the signal Sp indicates for at least a predetermined minimum amount of time that no magnitude control gesture was recognized. The magnitude control unit 14 includes a sample and hold module S/H. In response to the clock signal Sabs the sample and hold module S/H samples and stores the current setting of the magnitude I, which is denoted as c. The magnitude control unit 14 further has a storage space Y for storing the first delta value y and a storage space X for storing the second delta value x. Using a first and a second adder element A1, A2, a subtraction element S1 and a multiplier element M1, the magnitude control unit calculates the magnitude I as:

I=min(max(J,0),1), wherein

J=(c−y)+(x+y)p

The minmax function Mm indicated in FIG. 7 clips the value of I between 0 and 1.

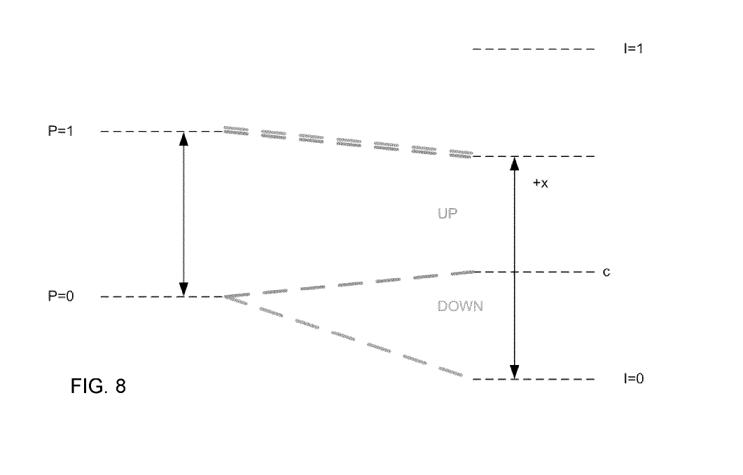

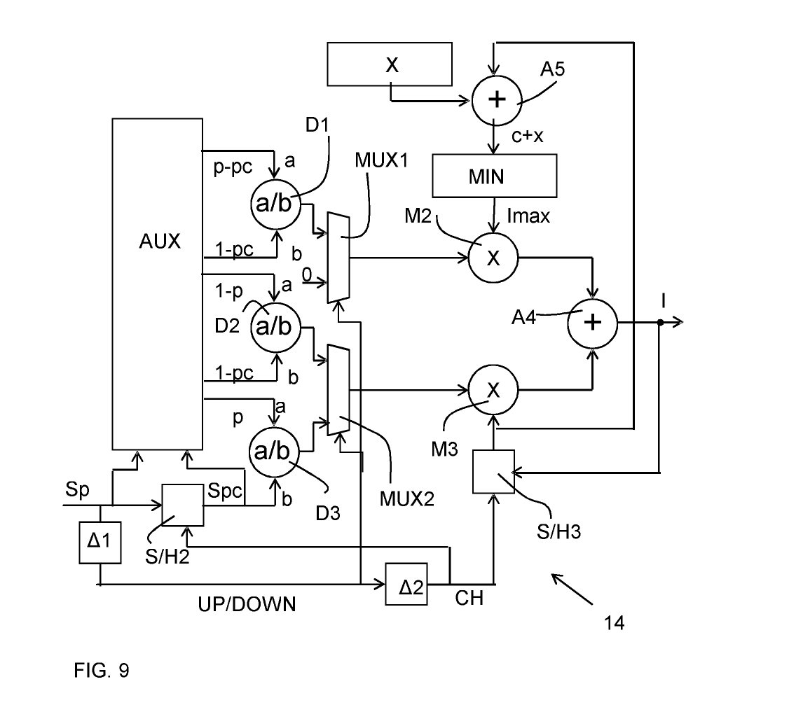

FIGS. 8 and 9 illustrate a variation of the embodiment of FIGS. 6 and 7. As shown in FIG. 8, this variation of the gesture control device provides for an asymmetric response that allows the user to increase the controlled magnitude I to a value that is at most a predetermined amount x higher than the currently selected reference value c or to decrease the controlled magnitude to 0.

FIG. 9 shows an exemplary implementation of the magnitude control unit 14. The magnitude control unit 14 receives a signal Sp from the gesture control interface 12, signaling a position p indicated by the user. The magnitude control unit 14 has a first binary differentiator Δ1 that determines whether the currently indicated position p changes in a positive or a negative sense and indicates this with the signal “UP/DOWN”. A further binary differentiator Δ2 is provided that provides a signal CH indicating changes in the signal “UP/DOWN”. Upon detection of a change as indicated by signal CH, the current value of the position p, indicated as pc is sampled in a sample and hold unit S/H2 and indicated by this unit as a signal Spc. Simultaneously a further sample and hold unit S/H3 samples the current value of the magnitude I as the value c. The magnitude control unit 14 further has an auxiliary calculation unit AUX that calculates the values p−pc, 1−pc, and 1−p. Three dividers D1, D2, D3 are provided. Therein the first divider D1 calculates

$$( \frac{p - pc}{1 - pc} ) ,$$

the second divider D2 calculates

$$( \frac{1 - p}{1 - pc} )$$

and the third divider D3 calculates

$$( \frac{p}{pc} ) .$$

A first multiplexer MUX1 selects the value from the first divider D1 if the signal UP/DOWN signals an increasing gesture position, and selects the value 0 if the signal UP/DOWN signals an decreasing gesture position. A second multiplexer MUX2 selects the value from the second divider D2 if the signal UP/DOWN signals an increasing gesture position, and selects the value from the third divider D3 if the signal UP/DOWN signals an decreasing gesture position. A multiplier M2 multiplies the value selected by the first multiplexer MUX1 with the value Imax. Therein Imax is the minimum of the value of the absolute upper bound for the magnitude, e.g. 1 and the value c+x. The latter value is calculated by adder A5, from the delta value x stored in storage space X and from the value c provided by the sample and hold unit S/H3. A multiplier M3 multiplies the value selected by the second multiplexer MUX2 with the value c obtained from the sample and hold unit S/H3. The values calculated by M2 and M3 are added by adder A4, and therewith the value I of the magnitude as controlled by the user is obtained.

Summarizing, presume the current position is pc in the range from 0 to 1 and the current magnitude is c in the range from 0 to 1. Presume further that the current maximum for the window is Imax. When moving upward in this state, the response I is

$$I = c + ( \frac{p - pc}{1 - pc} ) ( I max - c )$$

Which is equivalent to

$$I = ( \frac{1 - p}{1 - pc} ) c + ( \frac{p - pc}{1 - c} ) I max$$

Accordingly the user can change the magnitude from the value c to the value Imax when moving from the current position pc to the upper boundary position p=1. When moving downwards, the response is

$$I = ( \frac{p}{pc} ) c$$

Accordingly the user can change the magnitude from the value Ic to the value 0 when moving from the current position pc to the lower boundary position p=0. When detecting a change in direction from upwards or downwards, the values c and pc should be replaced by the latest respective values of I and p before the change in direction, in order to prevent discontinuities.

As will be apparent to a person skilled in the art, the elements listed in the system and arrangement claims are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

It will be understood that, although the terms first, second, third etc. may be used herein to describe various elements, components, modules and/or units, these elements, components, modules and/or units should not be limited by these terms. These terms are only used to distinguish one element, component, module and/or unit from another element, component, module and/or unit. Thus, a first element, component, module and/or unit discussed herein could be termed a second element, component, module and/or unit without departing from the teachings of the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

1. A gesture control device for use with a controllable device, wherein said gesture control device enables controlling a magnitude of a perceivable output of the controllable device within a predetermined magnitude range according to a magnitude control gesture, the gesture control device including
a gesture control interface to recognize gestures and to provide a detection signal indicative of recognized gestures,
a magnitude control unit to generate a device control signal indicative for the magnitude of the perceivable output in response to said detection signal,
characterized in that the gesture control interface is capable of recognizing at least one sub-range select gesture that corresponds to a selection by said magnitude control unit of a magnitude sub-range of said predetermined magnitude range and wherein said magnitude control unit limits the controlled magnitude to within said magnitude sub-range.

2. The gesture control device according to claim 1, wherein a detection signal provided by said gesture control interface in response to a magnitude control gesture indicates a value limited to a control range and wherein a selection of the magnitude sub-range is effected by mapping said control range to a magnitude sub-range of said predetermined magnitude range.

3. The gesture control device according to claim 1, wherein the at least one sub-range select gesture comprises a first and a second sub-range select gesture, wherein the first sub-range select gesture corresponds to a selection by said magnitude control unit of a magnitude sub-range of lower magnitudes than a currently selected sub-range and wherein the second sub-range select gesture corresponds to a selection by said magnitude control unit of a magnitude sub-range of higher magnitudes than the currently selected magnitude sub-range.

4. The gesture control device according to claim 3, wherein the gesture control interface is capable of recognizing an object along a path between a first and a second spatial boundary, and wherein the first sub-range select gesture is a transition of the object through the first spatial boundary, in a direction from the second spatial boundary to the first spatial boundary, wherein the second sub-range select gesture is a transition of the object through the second spatial boundary, in a direction from the first spatial boundary to the second spatial boundary, and wherein the magnitude control gesture is one of a position and a movement of the object between said first and said second spatial boundary.

5. The gesture control device according to claim 1, wherein said at least one sub-range select gesture is an absence of a magnitude control gesture for a predetermined minimum amount of time, wherein upon detection of said absence for the predetermined amount of time the current magnitude sub-range is set to a sub-range of magnitudes ranging from a lower magnitude being equal to a presently selected magnitude minus a first delta value to a higher magnitude being equal to the presently selected magnitude plus a second delta value.

6. The gesture control device according to claim 5, wherein said first and said second delta value are at least substantially equal.

7. The gesture control device according to claim 5, wherein said first and said second delta value are substantially different.

8. The gesture control device according to claim 4, wherein the magnitude control gesture is a position between said first and said second spatial boundary, wherein a reference position between said first and second spatial boundary corresponds to a current setting of the magnitude, and wherein the reference position is distanced from a central position between the first and the second spatial boundary.

9. A gesture control method for use with a controllable device, wherein said gesture control method enables controlling a magnitude of a perceivable output of the controllable device within a predetermined magnitude range using a magnitude control gesture, the gesture control method including
providing a detection signal indicative of detected gestures, where
and
in response to a magnitude control gesture providing a control signal that is indicative for a magnitude limited to a range and
controlling the controllable device with said control signal,
characterized in that said range is a magnitude sub-range that is selected from said predetermined magnitude range in response to a sub-range select gesture.

10. The gesture control method according to claim 9, wherein a detection signal provided in response to a magnitude control gesture indicates a value limited to a control range and wherein a selection of the magnitude sub-range is effected by mapping said control range to said magnitude sub-range.

11. The gesture control method according to claim 9, wherein the at least one sub-range select gesture comprises a first and a second sub-range select gesture, wherein upon detection of the first sub-range select gesture a magnitude sub-range of lower magnitudes is selected than a currently selected sub-range and wherein upon detection of the second sub-range select gesture a magnitude sub-range of higher magnitudes is selected than the currently selected magnitude sub-range.

12. The gesture control method according to claim 11, wherein the first sub-range select gesture is a transition of an object through a first spatial boundary, in a direction from a second spatial boundary to the first spatial boundary, wherein the second sub-range select gesture is a transition of the object through the second spatial boundary, in a direction from the first spatial boundary to the second spatial boundary, and wherein the magnitude control gesture is one of a position and a movement of the object between said first and said second spatial boundary.

13. The gesture control method according to claim 9, comprising
detecting whether a magnitude control gesture has been absent for a predetermined minimum amount of time,
if such absence is detected setting the current magnitude sub-range to a sub-range of magnitudes ranging from a lower magnitude being equal to a presently selected magnitude minus a first delta value to a higher magnitude being equal to the presently selected magnitude plus a second delta value.

14. A storage medium comprising a program that when executed by a programmable device performs the steps of the method of claim 9.

15. A system comprising the gesture control device according to claim 1 and a controllable device controlled by the gesture control device.
